(19) United States
(12) Patent Application Publication
(10) Pub. No.: US 2020/0017206 A1
(43) Pub. Date: Jan. 16, 2020

(54) TAIL ROTOR SYSTEM INCLUDING AN ELECTRIC MOTOR

(71) Applicant: Sikorsky Aircraft Corporation, Stratford, CT (US)

(72) Inventors: Peter J. Waltner, Royal Palm Beach, FL (US); Nikolas Andrew Macko, Stuart, FL (US); Daniel Bazzani, Jupiter, FL (US)

(21) Appl. No.: 16/033,295

(22) Filed: Jul. 12, 2018

(51) Int. Cl. B64C 27/82; B64C 27/06; B64C 27/14; H02K 11/00

(52) U.S. Cl. CPC B64C 27/82; B64C 27/06; B64C 2027/8209; H02K 11/0094; B64C 27/14

(57) ABSTRACT

A tail rotor system for an aircraft includes a tail rotor hub, a tail rotor drive shaft mechanically connected to the tail rotor hub, and an electric motor coupled to the tail rotor drive shaft.

### BACKGROUND

The subject matter disclosed herein generally relates to the art of air vehicles and, more particularly, to a tail rotor system including an electric motor.

Air vehicles, such as rotary wing aircraft, typically include a main rotor system which provides lift and a tail rotor system that may provide yaw control or forward propulsion. In some arrangements, the main rotor system may also provide forward propulsion. One or more engines provide power to the main and tail rotor systems. Air vehicles typically include an aircraft maximum gross weight limitation. This gross weight limitation includes weight of the air vehicle itself including fuel, passengers, crew and cargo.

Various conditions may reduce flight operations below a maximum gross vehicle weight. Operation type as well as weather conditions may place constraints on gross vehicle weight limits. That is, wind, rain, temperature, humidity, operational, and other factors may limit take-off weight below that of a max gross weight for the air vehicle. Reducing take-off weight may negatively affect mission performance

### BRIEF DESCRIPTION

According to an exemplary embodiment, a tail rotor system for an aircraft includes a tail rotor hub, a tail rotor drive shaft mechanically connected to the tail rotor hub, and an electric motor coupled to the tail rotor drive shaft.

In addition to one or more of the features described above, or as an alternative, in further embodiments the electric motor is mounted directly about the tail rotor drive shaft.

In addition to one or more of the features described above, or as an alternative, in further embodiments an energy storage device is electrically connected to the electric motor.

In addition to one or more of the features described above, or as an alternative, in further embodiments the electric motor comprises a motor generator operable to deliver power to the tail rotor drive shaft in a first configuration and to deliver power to the energy storage device in a second configuration.

In addition to one or more of the features described above, or as an alternative, in further embodiments a controller is operatively connected to the electric motor and connectable to an aircraft control system.

In addition to one or more of the features described above, or as an alternative, in further embodiments a support bulkhead is detachably mountable in the aircraft, the electric motor being mounted to the support bulkhead.

In addition to one or more of the features described above, or as an alternative, in further embodiments another electric motor is coupled to the tail rotor drive shaft adjacent the electric motor.

According to another exemplary embodiment, an aircraft includes a fuselage, a prime mover supported by the fuselage, a gear system mechanically connected with the prime mover, a main rotor system mechanically connected to the gear system, and a tail rotor system including a tail rotor hub, a tail rotor drive shaft mechanically connected to the tail rotor hub and the gear system, and an electric motor coupled to the tail rotor drive shaft.

In addition to one or more of the features described above, or as an alternative, in further embodiments the electric motor is mounted directly about the tail rotor drive shaft.

In addition to one or more of the features described above, or as an alternative, in further embodiments an energy storage device is electrically connected to the electric motor.

In addition to one or more of the features described above, or as an alternative, in further embodiments the electric motor comprises a motor generator operable to deliver power to the tail rotor drive shaft in a first configuration and to deliver power to the energy storage device in a second configuration.

In addition to one or more of the features described above, or as an alternative, in further embodiments a controller operatively is connected to the electric motor and connectable to an aircraft control system.

In addition to one or more of the features described above, or as an alternative, in further embodiments a support bulkhead detachably mountable to the fuselage, the electric motor being mounted to the support bulkhead.

In addition to one or more of the features described above, or as an alternative, in further embodiments another electric motor coupled to the tail rotor drive shaft adjacent the electric motor.

In addition to one or more of the features described above, or as an alternative, in further embodiments the electric motor is mounted to the tail rotor drive shaft between the gear system and the tail rotor hub.

According to yet another exemplary embodiment, a method of operating a tail rotor system for a vertical takeoff and landing (VTOL) aircraft includes recognizing, through an aircraft management system, an electric motor coupled to a tail rotor drive shaft of the VTOL aircraft, determining one of a torque requirement, a power requirement, and a rotor speed requirement of the VTOL aircraft, and activating the electric motor based on the one of the torque requirement, the power requirement, and the rotor speed requirement of the VTOL aircraft.

In addition to one or more of the features described above, or as an alternative, in further embodiments one of a presence and an absence of an energy storage device connected to the electric motor is recognized.

In addition to one or more of the features described above, or as an alternative, in further embodiments activating the electric motor includes operating the electric motor as a generator to produce electrical power.

In addition to one or more of the features described above, or as an alternative, in further embodiments recognizing the electric motor includes recognizing an absence of the electric motor.

In addition to one or more of the features described above, or as an alternative, in further embodiments power requirements in an aircraft management system are updated based on each of a presence and an absence one of the electric motor and the presence and absence of an energy storage device.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF DRAWINGS

FIG. 1 depicts an aircraft including a tail rotor system having an electric motor, in accordance with an exemplary embodiment; and

FIG. 2 depicts a portion of the tail rotor system, in accordance with an aspect of an exemplary embodiment.

### DETAILED DESCRIPTION

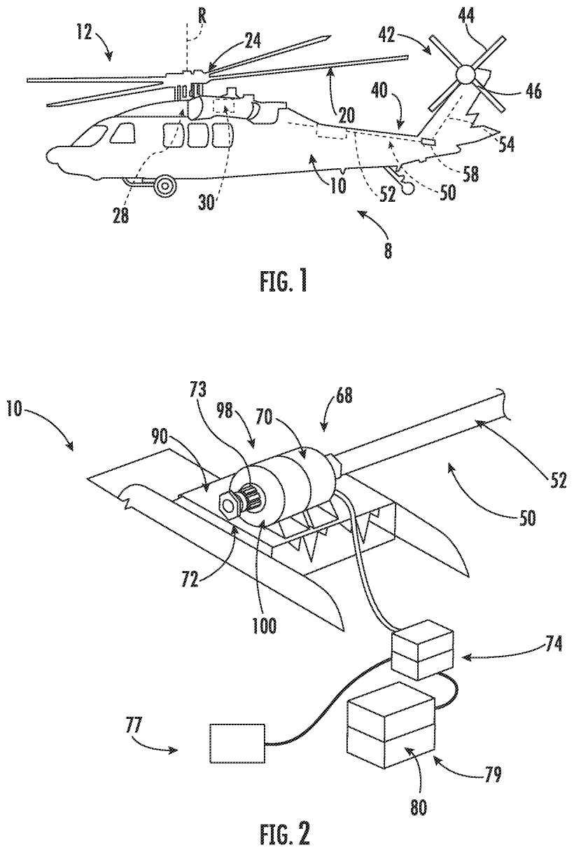

A vertical takeoff and landing (VTOL) or rotary wing aircraft, in accordance with an exemplary embodiment, is generally indicated at 8 in FIG. 1. Rotary wing aircraft 8 including a fuselage 10 that supports a main rotor system 12, which rotates about a main rotor axis R. Main rotor system 12 includes a plurality of rotor blades 20 rotatable about a main rotor axis “R”. Plurality of rotor blades 20 is mounted to a rotor hub 24.

Main rotor system 12 is driven by a gear system 28 coupled to one or more prime movers, indicated generally at 30. Aircraft 8 includes an extending tail 40 that supports a tail rotor system 42 including a plurality of tail rotor blades, indicated generally at 44 supported by a tail rotor hub 46. Tail rotor system 42 may be operatively coupled to gear system 28 through a tail rotor drive shaft 50. Tail rotor drive shaft 50 includes a first shaft portion 52 extending from gear system 28 and a second shaft portion 54 extending to tail rotor hub 46. First shaft portion 52 and second shaft portion 54 may be connected through another gear system 58.

Reference will now be made to FIG. 2 in describing tail rotor system 42 in accordance with an exemplary embodiment. Tail rotor system 42 includes a first electric motor 68 coupled to first shaft portion 52. First electric motor 68 may be operated to provide auxiliary power to tail rotor system 42 in the event more power may be needed by main rotor system 12. In an embodiment, first electric motor 68 extends about and is directly coupled to first shaft portion 52. First electric motor 68 may take the form of a motor/generator 70 that not only provides input power to tail rotor system 42 but may also generate electrical energy when driven by first shaft portion 52. In the embodiment shown, first electric motor 68 is mounted to tail rotor drive shaft 50 adjacent an end portion 72 of first shaft portion 52. End portion 72 may include splines 73 that provide an interface to first electric motor 68. Alternatively, motor/generator 70 may include a rotor portion (not shown) which may be integrated into first shaft portion 52.

In accordance with an exemplary aspect, first electric motor 68 is connected to a control system 74 which, in turn, is coupled to an aircraft management system 77. Aircraft management system 77 may selectively activate first electric motor 68 to provide power or deliver a motive force to tail rotor hub 46 in the event main rotor system 12 requires more power and/or operational speed from prime mover(s) 30. That is, aircraft management system 77 may determine one or more of a torque requirement, a power requirement, and a rotor speed requirement of VTOL aircraft 10. Based on the one or more of the torque requirement, power requirement and rotor speed requirement, power may be provided to first electric motor 68 through an onboard power system (not shown) or by an energy storage device 79 which could take the form of a battery 80. Of course, it should be understood that energy storage device may take on a variety of forms including, for example, capacitors and/or flywheels. When not providing power, electric motor 68 may be operated as a generator and used to recharge energy storage device 79 and/or provide power to other aircraft systems. When configured to provide aircraft power, the electric motor 68 may eliminate the need of for one or more generators on aircraft 8.

In one embodiment, aircraft management system 77 works in concert with control system 74 to limit the power delivered to first shaft portion 52 below a variable limit which may be a function of tail rotor power. In this manner, tail rotor system 42 may be retrofitted into an aircraft without requiring requalification of a gear system which may be required if the system were allowed to back-drive significant power from first shaft portion 52 through the end portion 72 and into the gear system.

In further accordance with an exemplary aspect, first electric motor 68 is mounted to a support bulkhead 90 connected to fuselage 10 and/or first shaft portion 52. In this manner, when operational requirements dictate that the operational gross weight is less than the aircraft maximum gross weight and additional power would be beneficial to increasing the operational weight, additional power may be provided to aircraft 8 by connecting electric motor 68 to tail rotor drive shaft 50. However, if auxiliary power may not be required for aircraft 8 to achieve aircraft maximum gross weight under the considered aircraft operational constraints, electric motor 68 may be removed from fuselage 10 to save weight and increase carrying capacity of aircraft 8.

In accordance with an exemplary aspect, electric motor 68 could be installed seasonally, e.g., during the summer months when prime mover(s) 30 may not produce power at a level that would enable operations at the aircraft maximum gross weight. Electric motor 68 could be un-installed and removed at other times, such as during winter months, when prime mover(s) 30 produce sufficient power due to potentially favorable ambient conditions. In another exemplary aspect, electric motor 68 could be installed to reconfigure an aircraft between operational modes if the primary mission of the aircraft changes from a mission which would not benefit from additional power to reach aircraft 8 maximum gross weight to a mission which would benefit from supplemental power.

In further accordance with exemplary aspects, aircraft management system 77 communicates with electric motor 68, motor/generator 70, control system 74, and energy storage device 79 in order to ensure that any limits of these systems and/or aircraft 8 are not exceeded. The implementation of these limits may be concentrated in one system or separated between any one of these systems. Additionally, aircraft management system 77 reports current vehicle configuration to the pilot, flight control computer (not shown), and/or other aircraft systems such that they may respond according to the current capability of the aircraft. For example, energy storage device 79 may not be installed in aircraft 8 on one portion of a mission to save weight. Energy storage device 79 may then be installed in aircraft 8 during another portion of the mission when weight is not an issue to increase operational capability.

As changing energy storage device 79 may change both the power delivery capability of electric motor 68 and energy capacity available to produce a desired power for a given duration, aircraft management system 77 reacts to any such changes, updating limits and pilot displays as appropriate. In the exemplary embodiment, changes and/or modifications to tail rotor system 42 may be updated to aircraft management system 77 to reflect current power capabilities of aircraft 8 automatically. That is, each component of tail rotor system 42 may signal its presence or absence from aircraft 8 to energy management system 77. In another embodiment, aircraft management system 77 may be updated manually via aircrew inputs or aircraft management system software updates.

At this point, it should be appreciated that the exemplary embodiments describe a system for providing additional and/or auxiliary power directly to a tail rotor drive shaft. The system may provide power independent of aircraft prime movers. That is the system may be powered by one or more batteries. The system may be readily installed and/or removed from the aircraft as needed and may be retrofittable to existing aircraft systems. Further, while shown and described as a single electric motor, it should be understood that another electric motor, such as indicated at 98, may also be mounted to the tail rotor drive shaft. It should be further understood that another electric motor 98 may take the form of another motor/generator 100. Further, the number and specifications of each of electric motor 68, motor/generator 70, control system 74, and/or energy storage device 79 may vary. The installation and/or removal of, as well as the specifications of, electric motor 68, motor/generator 70 and energy storage device 79 may be communicated to aircraft management system 77.

What is claimed is:

1. A tail rotor system for an aircraft comprising:
a tail rotor hub;
a tail rotor drive shaft mechanically connected to the tail rotor hub; and
an electric motor coupled to the tail rotor drive shaft.

2. The tail rotor system according to claim 1, wherein the electric motor is mounted directly about the tail rotor drive shaft.

3. The tail rotor system according to claim 1, further comprising: an energy storage device electrically connected to the electric motor.

4. The tail rotor system according to claim 3, wherein the electric motor comprises a motor generator operable to deliver power to the tail rotor drive shaft in a first configuration and to deliver power to the energy storage device in a second configuration.

5. The tail rotor system according to claim 1, further comprising: a controller operatively connected to the electric motor and connectable to an aircraft control system.

6. The tail rotor system according to claim 1, further comprising: a support bulkhead detachably mountable in the aircraft, the electric motor being mounted to the support bulkhead.

7. The tail rotor system according to claim 1, further comprising: another electric motor coupled to the tail rotor drive shaft adjacent the electric motor.

8. An aircraft comprising:
a fuselage;
at least one prime mover supported by the fuselage;
a gear system mechanically connected with the at least one prime mover;
a main rotor system mechanically connected to the gear system; and
a tail rotor system including a tail rotor hub, a tail rotor drive shaft mechanically connected to the tail rotor hub and the gear system, and an electric motor coupled to the tail rotor drive shaft.

9. The aircraft according to claim 8, wherein the electric motor is mounted directly about the tail rotor drive shaft.

10. The aircraft according to claim 8, further comprising: an energy storage device electrically connected to the electric motor.

11. The aircraft according to claim 10, wherein the electric motor comprises a motor generator operable to deliver power to the tail rotor drive shaft in a first configuration and to deliver power to the energy storage device in a second configuration.

12. The aircraft according to claim 8, further comprising: a controller operatively connected to the electric motor and connectable to an aircraft control system.

13. The aircraft according to claim 8, further comprising: a support bulkhead detachably mountable to the fuselage, the electric motor being mounted to the support bulkhead.

14. The aircraft according to claim 8, further comprising: another electric motor coupled to the tail rotor drive shaft adjacent the electric motor.

15. The aircraft according to claim 8, wherein the electric motor is mounted to the tail rotor drive shaft between the gear system and the tail rotor hub.

16. A method of operating a tail rotor system for a vertical takeoff and landing (VTOL) aircraft comprising:
recognizing, through an aircraft management system, an electric motor coupled to a tail rotor drive shaft of the VTOL aircraft;
determining one of a torque requirement, a power requirement, and a rotor speed requirement of the VTOL aircraft; and
activating the electric motor based on the one of the torque requirement, the power requirement, and the rotor speed requirement of the VTOL aircraft.

17. The method of claim 16, further comprising: recognizing one of a presence and an absence of an energy storage device connected to the electric motor.

18. The method of claim 16, wherein activating the electric motor includes operating the electric motor as a generator to produce electrical power.

19. The method of claim 16, wherein recognizing the electric motor includes recognizing an absence of the electric motor.

20. The method of claim 16, further comprising: updating power requirements in an aircraft management system based on each of a presence and an absence of the electric motor and the presence and absence of an energy storage device.
